(19) United States
(12) Patent Application Publication
(10) Pub. No.: US 2025/0278246 A1
(43) Pub. Date: Sep. 4, 2025

(54) SYSTOLIC ARITHMETIC ARRAY DEVICE AND METHOD FOR CONTROLLING

(71) Applicant: Fujitsu Limited, Kawasaki-shi (JP)

(72) Inventors: Katsuhiro YODA, Kodaira (JP); Toshihiro SHIMIZU, Sagamihara (JP); Makiko ITO, Kawasaki (JP)

(73) Assignee: Fujitsu Limited, Kawasaki-shi (JP)

(21) Appl. No.: 19/050,166

(22) Filed: Feb. 11, 2025

(30) Foreign Application Priority Data
Mar. 4, 2024 (JP) 2024-031973

(51) Int. Cl. G06F 7/57

(52) U.S. Cl. CPC G06F 7/57

(57) ABSTRACT

A device includes a systolic arithmetic array including multiple arithmetic operators connected in an array and an adjuster connected to one or more most-downstream arithmetic operators. Each arithmetic operator shifts multiple bits in an exponent part of a result of an arithmetic operation performed on input data in accordance with a value of one or more bits in the exponent part, updates shift information representing a cumulative amount of shifting made by at least one arithmetic operator, and outputs data obtained by shifting the bits in the exponent part, as the input data, to a subsequent arithmetic operator or the adjuster being a downstream entity connected to a downstream side of the arithmetic operator, and outputs the shift information to the downstream entity. The adjuster adjusts, based on the shift information from each most-downstream arithmetic operator, the input data from the each most-downstream arithmetic operator.

### CROSS-REFERENCE TO RELATED APPLICATION

This application is based upon and claims the benefit of priority of the prior Japanese Patent application No. 2024-031973, filed on Mar. 4, 2024, the entire contents of which are incorporated herein by reference.

### FIELD

The embodiment discussed herein relates to a systolic arithmetic array device and a method for controlling.

### BACKGROUND

In computation for general-purpose matrix product or computation for an Artificial Intelligence (AI), a systolic arithmetic array (hereinafter, sometimes simply referred to as “arithmetic array”) including multiple arithmetic elements (arithmetic operators) connected in an array (matrix) is sometimes used.

Each of the arithmetic elements of the arithmetic array perform unit-based arithmetic operation processes such as addition and multiplication on input data, and output the results of the arithmetic operations as input data to downstream arithmetic elements. This configuration allows the arithmetic array to omit registers that store results of arithmetic operations and is therefore superior in power performance as compared with typical Graphics Processing Units (GPUs), Central Processing Units (CPUs), or others.

In typical AI computation, the accuracy of a numerical value expressed in 32-bit floating-point format (Floating Point (FP) 32) is sometimes adequate. For the above, it is conceivable to improve computational performance and power performance by causing the arithmetic array to perform computation with lower accuracy than FP 32 expressed by a floating-point format such as 16-bit floating-point format (FP16) and Brain Float (BF) 16.

However, since FP16 has a narrower expression range and a smaller resolution than FP32, there is possibility that an overflow that the absolute value of the numerical value of the computation result (result of an arithmetic operation) exceeds the upper limit of the expression range of FP16 or an underflow that the absolute value becomes below the lower limit of the expression range of FP16 may occur.

In order to suppress the occurrence of such overflow or underflow, an approach has been known which causes the expression rage of FP16 to be variable by multiplying a Scaling Factor (SF) with a computation (e.g., matrix computation) result in accordance with a progress of the computation.

For example, a related art is disclosed in US Patent Application Publication No. 2018/0322607.

### SUMMARY

According to an aspect of the embodiments, a systolic arithmetic array device includes: a systolic arithmetic array including a plurality of arithmetic operators connected in an array; and an adjuster connected to one or more arithmetic operators being most downstream in the systolic arithmetic array. Each of the plurality of arithmetic operators is configured to shift a plurality of bits in an exponent part of a result of an arithmetic operation performed on input data inputted into the arithmetic operator in accordance with a value of one or more bits in the exponent part of the result of the arithmetic operation, update shift information representing a cumulative amount of shifting made by at least one of the arithmetic operators in accordance with the shifting, and output data obtained by shifting the plurality of bits in the exponent part, as the input data, to a subsequent arithmetic operator or the adjuster being a downstream entity connected to a downstream side of the arithmetic operator, and output the shift information to the downstream entity. The adjuster is configured to adjust, based on the shift information inputted from each of the one or more arithmetic operators, the input data inputted from each of the one or more arithmetic operators.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an expression range corresponding to the bit number of a floating-point format;

FIG. 2 is a diagram illustrating an example of adjusting a SF;

FIG. 3 is a diagram illustrating an example of application of the SF to an arithmetic operation on a matrix product;

FIG. 4 is a block diagram schematically illustrating an example of a configuration of an arithmetic array device according to one embodiment;

FIG. 5 is a diagram illustrating an example of an operation performed by each Processing Element (PE) in an arithmetic array;

FIG. 6 is a block diagram schematically illustrating an example of a configuration of the PE of the one embodiment;

FIG. 7 is a block diagram schematically illustrating an example of a configuration of a SF determination updater;

FIG. 8 is a block diagram schematically illustrating an example of a configuration of a data reconstructor;

FIG. 9 is a block diagram schematically illustrating an example of a configuration of a SF adjuster;

FIG. 10 is a diagram illustrating an example of a table;

FIG. 11 is a flow diagram illustrating an example of an operation of each PE in the arithmetic array of the one embodiment;

FIG. 12 is a flow diagram illustrating an example of an operation of the SF adjuster of the one embodiment;

FIG. 13 is a block diagram schematically illustrating a configuration of an arithmetic array device according to a modification;

FIG. 14 is a block diagram schematically illustrating a configuration of the SF determination updater of the modification; and

FIG. 15 is a flow diagram illustrating an example of an operation of each PE in the arithmetic array of the modification.

### DESCRIPTION OF EMBODIMENT(S)

The computation for adjusting the SF includes obtaining of a maximum value of the computation result of the matrix computation and calculation of the SF based on the maximum value, and is performed serially between the matrix computation and the ensuing matrix computation. Such obtaining of the maximum value and the calculation of the SF are often performed in a CPU. For the above, when the arithmetic array is caused to carry out the arithmetic operation such as the matrix computation, calculation for adjusting the SF by the CPU may become overhead and therefore the computation performance of the arithmetic array may be lowered.

Hereinafter, an embodiment will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. Further, throughout the drawing to be referred in the following description, like reference numbers designate the same or substantially same elements unless described otherwise.

### (A) Explanation of Arithmetic Operation at Low Accuracy:

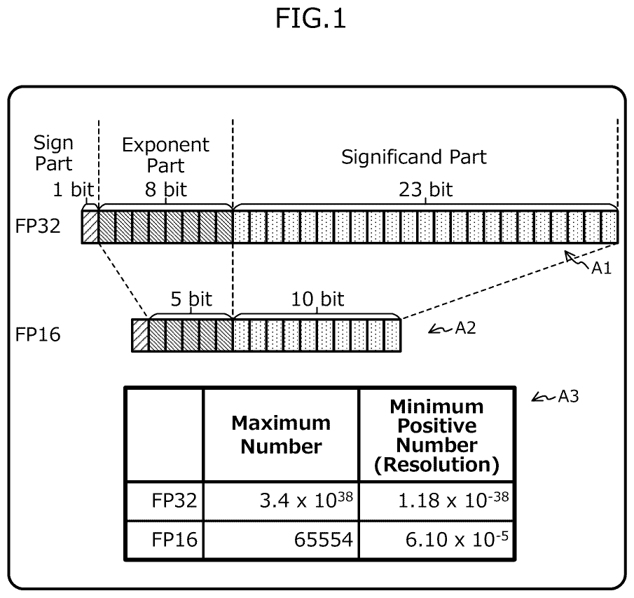

FIG. 1 is a diagram illustrating an example of an expression range (expressible range, hereinafter sometimes simply referred to as “range”) corresponding to the bit number of a floating-point format. A reference sign A1 illustrates a numerical value format of FP32, a reference sign A2 illustrates a numerical value format of FP16, and a reference sign A3 illustrates maximum values and minimum positive numbers (resolutions) of FP32 and FP16.

FP32 includes a one-bit sign part indicating positive or negative, an eight-bit exponent part indicating the number of decimal point shifts, and a 23-bit significand part indicating a numerical value after decimal point shift, and has the expression range the maximum value of which is 3.4×10³⁸ and the minimum positive number of which is 1.18×10⁻³⁸. FP16 includes a one-bit sign part, a five-bit exponent part, and a 10-bit significand part, and has the expression range the maximum value of which is 65554 and the minimum positive number of which is 6.10×10⁻⁵.

As such, although having a wide range of about 10¹⁰, FP16 has a narrower expression range and a smaller resolution as compared to FP32. For example, in regard of the expression range of FP16, if values of a computation result are uneven, the computation result may be outside the range of 6.10×10⁻⁵ to 65554, which is the expression range of FP16, and overflow or underflow is likely to occur. For example, in FP16, 70000 and 80000 are not distinguished from each other, and both are rounded to 65554 due to the overflow. Also, for example, in FP16, 0.0000001 and 0.0000005 are not distinguished from each other, and both are rounded to 6.10×10⁻⁵ due to the underflow.

Hereinafter, an arithmetic operation using a floating-point format (e.g., FP16, BF16, and FP8) having a lower accuracy than a floating-point format (e.g., FR32) having a sufficient accuracy to conduct the arithmetic operation is sometimes referred to as an arithmetic operation at a low accuracy or a low-accurate arithmetic operation.

One of the conceivable approaches to achieve the low-accurate arithmetic operation is to set the computation result within the range of FP 16 by multiplying a SF with the computation result. The SF is a number to be multiplied with the computation result to make the computation result fall within the range of FP16, and can be said the number of decimal point shifts.

For example, in a low-accurate arithmetic operation of a certain neural network (NN), it is assumed that a computation result of a first layer is in a range of 10⁻⁷ to 10⁻⁰ (i.e., outside the range of FP16) and a computation result of a second layer is in a range of 10⁻¹ to 10⁵ (within the range of FP16). By multiplying the entire computation result of the first layer by 10² as a SF, the computation result of the first layer can be set within FP16. As a result, a maximum value of the computation result of the second layer becomes 10⁷, which is out of the range of FP16. For the above, by multiplying the entire computation result of the second layer by 10⁻² as the SF, the computation result of the second layer can be set within the range of FP16.

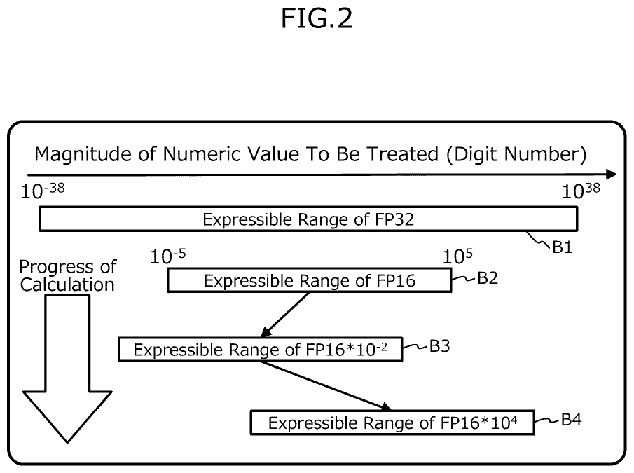

FIG. 2 is a diagram illustrating an example of adjusting the SF. A reference sign B1 indicates the expressible range of FP32, which is 10⁻³⁸ to 10³⁸, and a reference sign B2 indicates the expressible range of FP16, which is 10⁻⁵ to 10⁵. A reference sign B3 indicates an expressible range of FP16 (*10⁻²) when the SF is updated to 10⁻² as the calculation proceeds. A reference sign B4 indicates an expressible range of FP16 (*10⁴) when the SF is updated to 10⁴ as the calculation further proceeds. Thus, by using the SF, the expressible range of FP16 can be made movable.

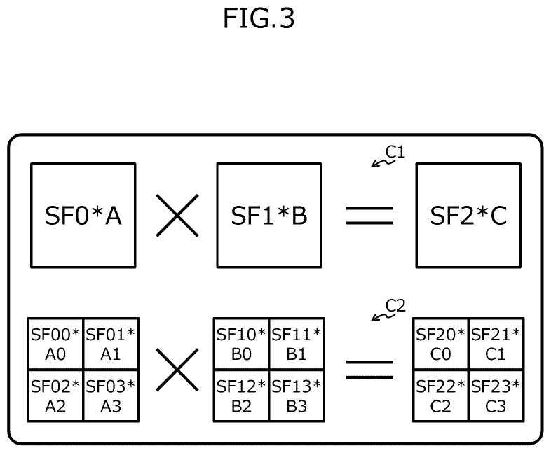

FIG. 3 is a diagram illustrating an example of application of the SF to an arithmetic operation on a matrix product. A reference sign C1 indicates an example in which each element of the matrices A, B, and C of the matrix product A×B=C is represented in the FP16 and the respective elements of the matrices A, B, and C are multiplied by SF0, SF1, and SF2, respectively. A reference sign C2 indicates an example in which the elements of the matrices A, B, and C are multiplied with respective different SFs. For example, the elements A0, A1, A2, and A3 of the matrix A are multiplied by SF00, SF01, SF02, and SF03, respectively. Similarly, the elements B0, B1, B2, and B3 of the matrix B are multiplied by SF10, SF11, SF12, and SF13, respectively. Similarly, the elements C0, C1, C2, and C3 of the matrix C are multiplied by SF20, SF21, SF22, and SF23, respectively.

As described above, by adjusting the SF for each predetermined unit in the computation, it is possible to achieve a high accuracy in a pseudo manner. The predetermined unit is, for example, a unit of a matrix computation, tiles or chunks obtained by splitting the matrix, or a layer of a Neural Network (NN). For example, by splitting convolutional computation of the NN into chunks and using different SFs for respective chunks, an accuracy degradation in a smaller floating-point format, such as FP16 or FP8, than FP32 can be abated.

The computation for adjusting the SF includes obtaining of a maximum value of the computation result of the matrix computation and calculation of the SF based on the maximum value, and is performed serially by a CPU between a plurality of the matrix computations performed by the arithmetic array. Therefore, the computation for adjusting the SF by the CPU becomes overhead, and a computation performance of the arithmetic array may be degraded.

As a solution to the above, the one embodiment describes an approach of suppressing a deterioration in the computation performance of the arithmetic array that performs the low-accurate arithmetic operation.

### (B) Example of Configuration of Arithmetic Array Device of One Embodiment:

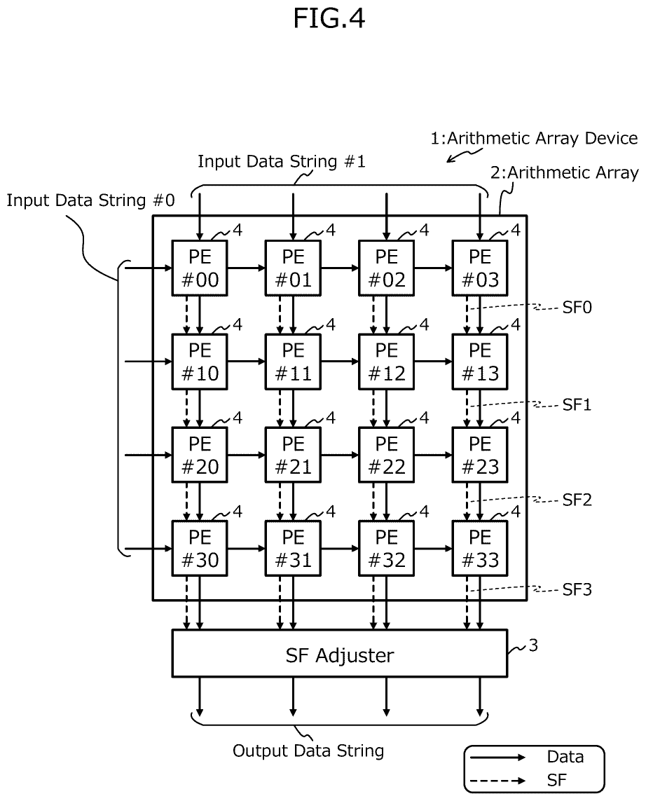

FIG. 4 is a block diagram schematically illustrating an example of a configuration of an arithmetic array device 1 according to one embodiment. The arithmetic array device 1 is a systolic arithmetic array device and is an example of an accelerator. As illustrated in FIG. 4, the arithmetic array device 1 includes, as a circuitry (hardware) configuration, an arithmetic array 2 and a SF adjuster 3 connected to the arithmetic array 2.

The arithmetic array 2 includes multiple Processing Elements (PEs) 4 connected in an array. The arithmetic array 2 is exemplified by, for example, a systolic array, a systolic arithmetic array such as a particular Coarse-Graine Reconfigurable Architecture (CGRA). An example of the particular CGRA is a CGRA implemented with a systolic array arithmetic operation logic.

The PE 4 is an example of an arithmetic operator, an arithmetic device, or an arithmetic circuit that performs various arithmetic operations, for example, unit-based operations such as addition and multiplication. Hereinafter, a particular PE 4 among the multiple PEs 4 may be represented as a PE #00 by using numbers #00 to #03, #10 to #13, #20 to #23, and #30 to #33 indicated in FIG. 4. The multiple PEs 4 may have a similar configuration to each other. The multiple PEs 4 are connected in a matrix along respective axial directions of a left-right direction (horizontal axis direction) and a top-bottom direction (vertical axis direction) of the drawing. The arithmetic array 2 may be provided with more than two PEs 4 with at least one column along the horizontal axis direction and at least two rows in the vertical axis direction.

Into the arithmetic array 2, an input data string #0 is inputted from one side (from the left of the drawing in FIG. 4) in the horizontal axis direction, and an input data string #1 is inputted from one side (from the top of the drawing in FIG. 4) in the vertical axis direction. The multiple PEs 4 propagate data in one direction to respective adjacent PEs 4 along each axis direction (see solid arrows in FIG. 4).

In the example of FIG. 4, the PEs 4 propagate data of a data string #0 from the left side of the drawing to the right side of the drawing along the horizontal axis direction. In addition, the PEs 4 propagate results of arithmetic operations performed by using the data of the data string #0 and data of the data string #1 from the top of the drawing to the bottom of the drawing along the vertical axis direction. Each of the input data strings #0 and #1 is input data to be subjected to the arithmetic operations in the arithmetic array device 1, and is, for example, matrix data. The input data string #0 is split into a row or column elements, and is respectively inputted into the PEs #00, #10, #20, and #30 corresponding to the respective elements. The input data string #1 is split into a row or column elements, and is respectively inputted to the PEs #01, #02, #03, and #04 corresponding to the respective elements.

Each of the multiple lowest (most-downstream) PEs 4 (PEs #30 to #33) in the vertical axis direction in the arithmetic array 2 is connected to the SF adjuster 3, and outputs the result of the arithmetic operation propagated in the vertical axis direction to the SF adjuster 3.

Hereinafter, on the basis of a certain PE 4, another PE 4 or the SF adjuster 3 that is connected from the certain PE 4 to the propagation direction (downstream stage) of data of the result of the arithmetic operation may be referred to as a “downstream (subsequent) PE 4” or the SF adjuster 3, a “downstream entity”, or simply a “downstream”. A case where the downstream is the SF adjuster 3 is a case where the certain PE 4 is positioned at the most downstream in the arithmetic array 2. In addition, seen from the downstream, the certain PE 4 may be referred to as a “upstream PE 4” or simply an “upstream”.

In the arithmetic array 2 according to the one embodiment, each PE 4 shifts multiple bits in the exponent part of the result of the arithmetic operation in accordance with a value of one or more bits in the exponent in the result of the arithmetic operation, and propagates (outputs), as data, a result of the arithmetic operation after the shift to the downstream. In addition, the PE 4 updates a value of the SF in accordance with the shifting, and propagates (outputs) the updated value of the SF along with the data to the downstream (see the dashed line in FIG. 4). The SF is an example of shift information indicating a cumulative amount of shifting made by at least one PE 4.

The SF adjuster 3 is one example of an adjuster connected to one or more most-downstream PEs 4 of the arithmetic array 2, adjusts input data inputted from each of the multiple most-downstream PEs 4 of the arithmetic array 2 on the basis of the value of the SF inputted from each of the multiple most-downstream PEs 4, and outputs the adjusted data, as an adjusted data string. Adjusting of the input data means that, for example, the value of input data which is different from its nature value due to the shifting of bits in the exponent part is adjusted to a “true value”. An output data string is an output data serving as a result of an arithmetic operation from the arithmetic array device 1 and is exemplified by a matrix (matrix product) data. The output data string may be stored, for example, in a memory such as a Random Access Memory (RAM), and used for a process by a processor of the CPU and the like.

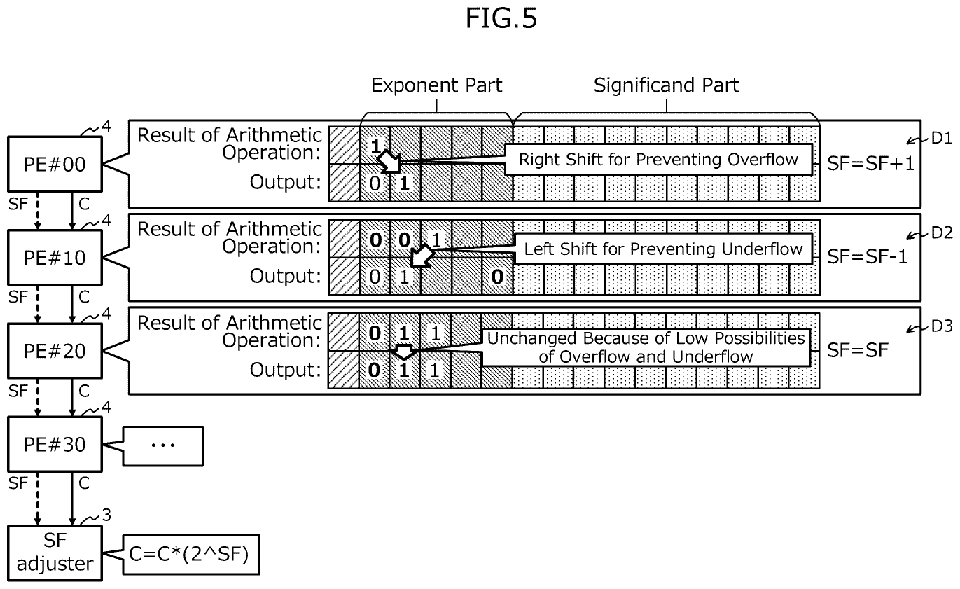

FIG. 5 is a diagram illustrating an example of an operation performed by each PE 4 in the arithmetic array 2. For the convenience, FIG. 5 illustrates the PEs #00, #10, #20, and #30 and the SF adjuster 3 of arithmetic array device 1, and omits illustration of the remaining PEs 4, the input data string, and the output data string.

As illustrated in FIG. 5, the PE 4 shifts multiple bits of the exponent part in accordance with the value of one or more bits of the exponent part in the result of the arithmetic operation. For example, the PE 4 multiplies the result of the arithmetic operation with a predetermined value and updates the value of the SF. The PE 4 regards the result of the arithmetic operation in which the bits in the exponent part are shifted as the data (denoted as “C” in FIG. 5) to be outputted to the downstream, and also regards the updated value of the SF as the value (denoted as “SF” in FIG. 5) of the SF to be outputted to the downstream, and outputs the data and the value to the downstream. In other words, the PE 4 propagates the updated SF along with the data C to the downstream.

For example, as illustrated in a reference sign D1, when the most significant bit (MSB) of the exponent part in the result of the arithmetic operation performed by the PE #00 is one, the PE #00 sets a value of the MSB of the exponent part to zero by right shifting the exponent part by one bit. In addition, the PE #00 adds 1 to the value of the SF in order to record that the exponent part is right shifted by one bit, which means that the value of the result of the arithmetic operation is increased by one digit. Then, the PE #00 outputs the result of the arithmetic result including the shifted (updated) exponent part to the downstream, and outputs the value of the SF after the addition (updating) to the downstream. This can prevent the occurrence of the overflow.

Also, as illustrated in a reference sign D2, when both the value of the most significant bit of the exponent part and a value of a bit lower by one bit than the most significant bit in the exponent part of the result of the arithmetic operation performed by the PE #10 are both zero, the PE #10 sets a value of the least significant bit of the exponent part to zero by left shifting the exponent part by one bit. In addition, the PE #10 subtracts one from the value of the SF in order to record that the exponent part is left shifted by one bit, which means that the value of the result of the arithmetic operation is decreased by one digit. Then, the PE #10 outputs the result of the arithmetic result including the shifted (updated) exponent part to the downstream, and outputs the value of the SF after the subtraction (updating) to the downstream. This can prevent the occurrence of the underflow.

Further, as illustrated in a reference sign D3, the PE #20 maintains the current value of the exponent part when the value of the most significant bit of the exponent part in the operation performed by the PE #20 is zero but the value of the bit lower by one bit than the most significant bit in the exponent part of the result is one. Furthermore, the PE #20 also maintains the current value of the SF. Then, the PE #10 outputs a result of an arithmetic operation performed by the PE #20 to the downstream and outputs the current value of the SF to the downstream. When the value of the most significant bit and the bit lower by one bit than the most significant bit of the exponent part are 01, it can be said that the result of the arithmetic result is in an appropriate position in the expressible range of the low-accuracy floating point format (e.g., FP16) due to the current value of the SF. This can be said that, in the present SF, the possibility of the occurrence of both of the overflow and the underflow is low. Therefore, the PE #20 maintains the current value of the SF.

The PE #30 performs the same process as any one of the PEs #00, #10, and #20 (reference signs D1 to D3) patterns, and outputs the result of the arithmetic operation and the SF to the SF adjuster 3.

The SF adjuster 3 adjusts, based on the value of the SF inputted from the PE #30, the data C (result of the arithmetic operation) inputted from the PE #30 to the true value. For example, the SF adjuster 3 updates the data C according to the following Equation (1). The updated data C may be outputted as a result of an arithmetic process performed by the arithmetic array device 1.

$$C = C * {2}^{SF} \qquad ( 1 )$$

### (C) Example of Configuration of PE:

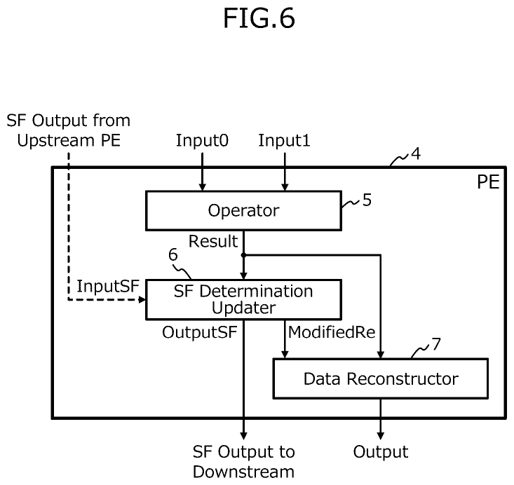

Next, description will now be made in relation to a configuration of the PE 4 of the one embodiment with reference to FIG. 6 to FIG. 10.

FIG. 6 is a diagram illustrating an example of the configuration of the PE 4 according to the one embodiment. As illustrated in FIG. 6, each of the multiple PEs 4 may include, as a circuitry (hardware) configuration, an operator 5, a SF determination updater 6, and a data reconstructor 7.

The operator 5 executes the arithmetic operation process on the input data (denoted as “Input0” and “Input1”) inputted into the PE 4, and outputs the result (denoted as “Result”) of the arithmetic operation. Example of the input data includes data of any element in the input data string #0 and data of any element in the input data string #1 (if the PE 4 is the most upstream) or input data from the data reconstructor 7 of the upstream PE 4 (if the PE 4 is not the most upstream). The most-upstream PEs 4 are the PEs #00, #01, #02, and #03 in the example of FIG. 4. Examples of the operator 5 may include various known arithmetic operating units that execute various arithmetic processes.

The SF determination updater 6 determines and updates the SF on the basis of the result (Result) of the arithmetic operation performed by the operator 5 and the SF (denoted by “InputSF”) outputted from the upstream PE4. As a result of determining and updating the SF, the SF determination updater 6 outputs the information (denoted by “ModifiedRe”) of an updated exponent part to the data reconstructor 7 and outputs the updated SF (denoted by “OutputSF”) to the downstream. Here, the SF determination updater 6 provided in the most upstream PEs 4 of the arithmetic array 2 may be set to fixedly detect zero as the InputSF.

The data reconstructor 7 reconstructs the data of the result of the arithmetic operation on the basis of the result (Result) of the arithmetic operation performed by the operator 5 and the information (ModifiedRe) of the exponent part updated by the SF determination updater 6, and outputs the reconstructed output data (denoted as “Output”) to the downstream. If the downstream is a certain PE 4, the output data (Output) becomes the input data (Input0 or Input1) of the certain PE 4 whereas, if the downstream is the SF adjuster 3, the output data becomes the input data into the SF adjuster 3.

The following explanation assumes that the arithmetic array device 1 executes the low-accuracy arithmetic operation of FP16, and the input data (Input), the result (Result) of the arithmetic operation, and the output data (Output) data are each 16-bit data expressed by [15:0]. The notation [15] represents the most significant bit (a leftmost bit in the FP16 illustrated in FIG. 1) in the data, and the notation [0] represents the least significant bit (a rightmost bit in the FP16 illustrated in FIG. 1) in the data.

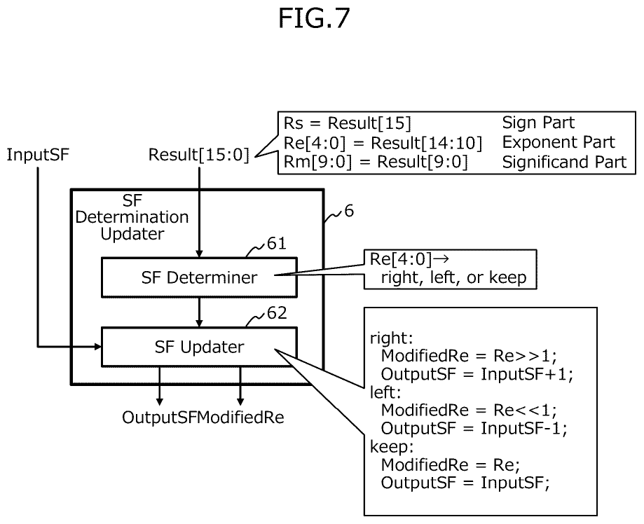

FIG. 7 is a block diagram schematically illustrating an example of a configuration of the SF determination updater 6. The SF determination updater 6 may illustratively include a SF determiner 61 and a SF updater 62. The following description sometimes indicates, in Result[15:0] representing the result of the arithmetic operation, Result[15] serving as the sign part by Rs, Result[14:10] serving as the exponent part by Re[4:0] or Re, and Result[9:0] serving as the significand part by Rm[9:0] or Rm.

On the basis of the value of the bit of the exponent part Re[4:0] of Result[15:0] representing the result of the arithmetic operation, the SF determiner 61 determines whether to perform the right-shift, the left-shift, or the maintenance as a process to be performed on the exponent part, and outputs information indicating the result of the determination to the SF updater 62. These information may be a predetermined signal such as a flag.

For example, when Re[4]=“1” (see a reference sign D1 in FIG. 5), the SF determiner 61 outputs information (right) indicating right shift to warn against the overflow because the bits up to the most significant bit of the exponent part are used.

In addition, when Re[4]=“0” and also Re[3]=“0” (see a reference sign D2 in FIG. 5), the SF determiner 61 outputs information (left) indicating left shift to warn against the underflow because the upper two bits are available.

Furthermore, when the exponent part is not in a condition for right shift or left shift, which is exemplified by a case where Re[4]=“0” and Re[3]=“1” (see a reference sign D3 in FIG. 5), the state of the exponent part is balanced and therefore the SF determiner 61 outputs information (keep) indicating maintenance to keep the current state.

The SF updater 62 updates (including keeps) Re[4:0] in accordance with the result of the determination made by the SF determiner 61, and as a processing result of the updating, outputs the information ModifiedRe of the updated exponent part to the data reconstructor 7. Further, the SF updater 62 updates (including keeps) the InputSF from the upstream PE 4 in accordance with the result of the determination made by the SF determiner 61, and outputs the OutputSF, as a processing result of the updating, to the downstream.

For example, when the result of the determination made by the SF determiner 61 indicates right shift (right), the SF updater 62 sets the result of the right shift Re[4:0](denoted by “Re>>1”) in the ModifiedRe, and sets the result of the addition of one to the InputSF in the OutputSF. The right shift of Re[4:0] may mean, for example, that Re[4:1] is set in ModifiedRe[3:0] and zero is set in ModifiedRe[4].

In addition, when the result of the determination made by the SF determiner 61 indicates left shift (left), the SF updater 62 sets the result of the left shift Re[4:0](denoted by “Re<<1”) in the ModifiedRe, and sets the result of the subtraction of one from the InputSF in the OutputSF. The left shift of Re[4:0] may mean, for example, that Re[3:0] is set in ModifiedRe[4:1] and zero is set in ModifiedRe[0].

Further, when the result of the determination made by the SF determiner 61 indicates maintenance (keep), the SF updater 62 sets Re[4:0] in the ModifiedRe and sets the InputSF in the OutputSF.

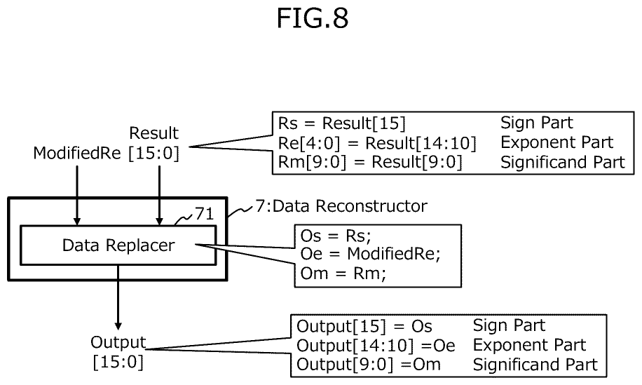

FIG. 8 is a block diagram schematically illustrating an example of the configuration of the data reconstructor 7. The data reconstructor 7 may illustratively include a data replacer 71. The following description sometimes indicates, in the output data Output[15:0], Output[15] serving as the sign part by Os, Output[14:10] serving as the exponent part by Oe[4:0] or Oe, and Output[9:0] serving as the significand part Om[9:0] or Om.

The data replacer 71 generates the output data Output[15:0] by replacing the exponent part Re[4:0] in the Result[15:0] serving as the result of the arithmetic operation by the information ModifiedRe of the updated exponent, part, and outputs the Output[15:0] to the downstream. For example, the data replacer 71 may generate Output[15:0] by setting, as data of Output[15:0], Os to Rs, ModifiedRe in place of Re to Oe, and Rm to Om.

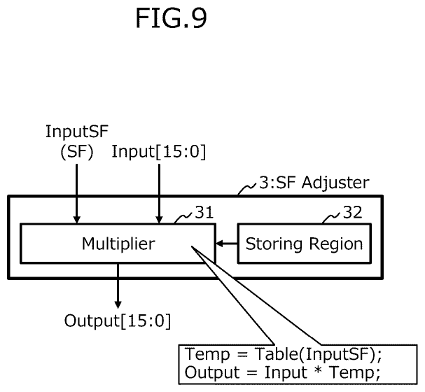

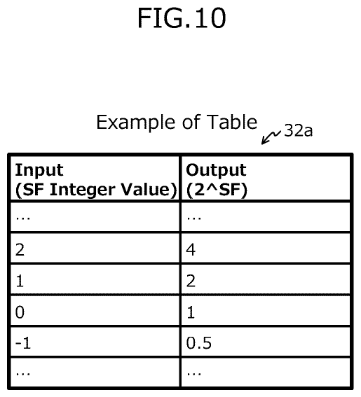

FIG. 9 is a block diagram schematically illustrating an example of the configuration of the SF adjuster 3, and FIG. 10 is a diagram illustrating an example of a table 32a. The SF adjuster 3 may illustratively include a multiplier 31 and a storing region 32.

The storing region 32 is a storing region achieved by a storing element (storing device) such as a register, a Static RAM (SRAM), a Read Only Memory (ROM), and stores the table 32a illustrated in FIG. 10. The table 32a is a table for converting integer value (InputSF) of the SF to a power of two (2^{InputSF}). For example, the storing region 32 may include an input/output circuit that outputs (obtains) 2^{InputSF} in response to an input (for convenience, denoted by Table(InputSF)) of the InputSF into the table 32a. In addition, in place of the storing region 32 and the table 32a, the SF adjuster 3 may be implemented with a circuit logic that outputs (obtains) 2^{InputSF} in accordance with Table (InputSF).

The multiplier 31 converts the InputSF inputted from the upstream PE 4 into 2^{InputSF} using table 32a of the storing region 32 or the circuit logic. For example, the multiplier 31 obtains, as a Temp, 2^{InputSF} that is the output from the Table(InputSF). Then, the multiplier 31 generates the output data Output[15:0] by multiplexing Input[15:0] inputted from the upstream PE 4 by 2^{InputSF} serving as Temp.

The multiplier 31 and storing region 32 illustrated in FIG. 9 may be provided corresponding one PE 4 among multiple PEs 4 (the PEs #30, #31, #32, and #33 in the example of FIG. 4) on the upstream side (the most downstream in the arithmetic array 2) of the SF adjuster 3. Accordingly, the SF adjuster 3 may include, for example, a set of the multiplier 31 and the storing region 32 for each PE 4 on the upstream side of the SF adjuster 3.

The multiplier 31 may be capable of processing inputs from two or more PEs 4 in parallel, and under this situation, the SF adjuster 3 may be provided with multipliers 31, the number of which is suitable for the number of processes that each multiplier 31 can execute in parallel and the number of PEs 4 on the upstream side of the SF adjuster 3. Also, the storing region 32 (or table 32a) may be capable of outputting results to two or more references (inputs of the InputSF) in parallel. In this case, the SF adjuster 3 may be provided with storing regions 32a (or tables 32a), the number of which corresponds to the number of results that each storing region 32a (or table 32a) can output in parallel and the number of PEs 4 on the upstream side of the SF adjuster 3.

### (D) Example of Operation:

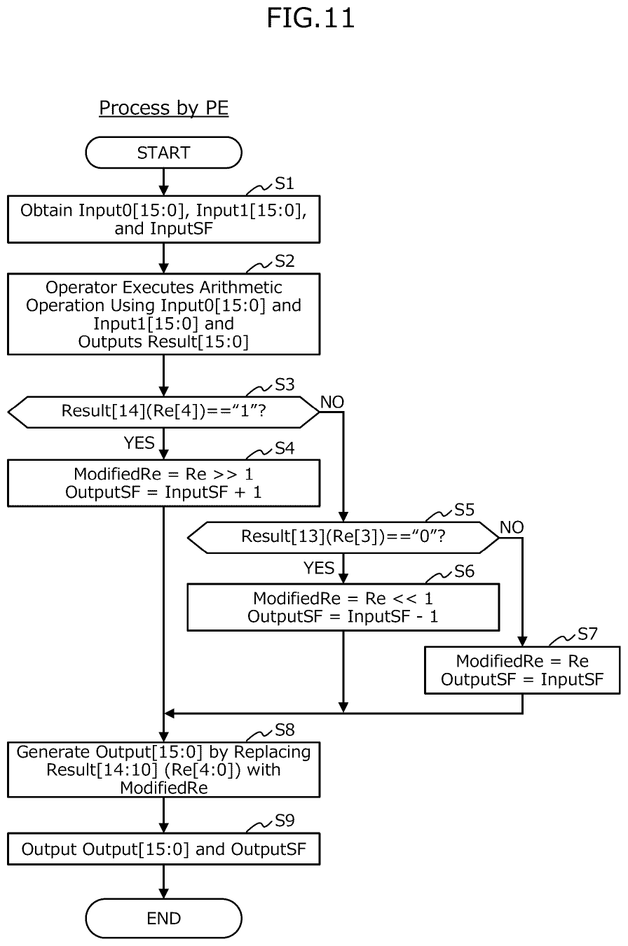

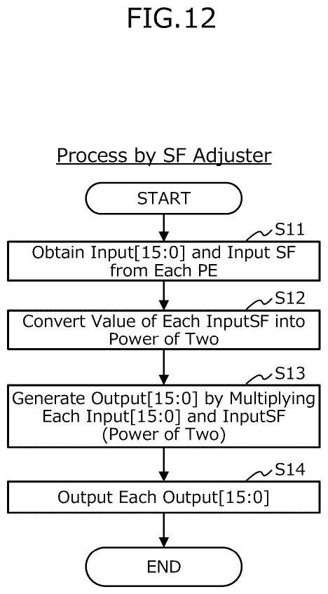

Next, description will now be made in relation to an example of an operation performed by the arithmetic array device 1 according to the one embodiment. FIG. 11 is a flow diagram illustrating an example of an operation of each PE 4 in the arithmetic array 2 of the one embodiment, and FIG. 12 is a flow diagram illustrating an example of an operation of the SF adjuster 3 of the one embodiment.

### (D-1) Example of an Operation of PE:

FIG. 11 illustrates an example of an operation related to an arithmetic operation process of a single cycle in each of the multiple PEs 4 included in the arithmetic array 2. As illustrated in FIG. 11, in Step S1, the PE 4 obtains Input0[15:0] and Input1[15:0] from the upstream PE 4 or the input data string, and obtains the InputSF from the upstream PE 4 or as a fixed value 0.

In Step S2, the operator 5 executes the arithmetic operation using Input0[15:0] and Input1[15:0], and outputs Result[15:0] as the result of the arithmetic operation.

In Step S3, the SF determiner 61 determines whether or not Result[14](Re[4]) in Result[15:0] is “one”. If Result[14](Re[4]) is “one” (YES in Step S3), the SF determiner 61 outputs the information indicating right shift as the determination result, and the process proceeds to Step S4. If Result[14](Re[4]) is not “one” (but is “zero”) (NO in Step S3), the process proceeds to Step S5.

In Step S4, the SF updater 62 generates the ModifiedRe by right shifting Re, generates the OutputSF by adding one to the InputSF, and outputs the ModifiedRe and the OutputSF. Then, the process proceeds to Step S8.

In Step S5, the SF determiner 61 determines whether or not Result[13](Re[3]) in Result[15:0] is “zero”. When Result[13](Re[3]) is “zero” (YES in Step S5), the SF determiner 61 outputs the information indicating left shift as the determination result, and the process proceeds to Step S6. If Result[13](Re[3]) is not “zero” (but is “one”) (NO in Step S5), the process proceeds to Step S7.

In Step S6, the SF updater 62 generates the ModifiedRe by left shifting Re, generates the OutputSF by subtracting one from the InputSF, and outputs the ModifiedRe and the OutputSF. Then, the process proceeds to Step S8.

In Step S7, the SF updater 62 sets the ModifiedRe to Re and the OutputSF to the InputSF, respectively, and outputs the ModifiedRe and the OutputSF. Then, the process proceeds to Step S8.

In Step S8, the data replacer 71 generates Output[15:0] by replacing Result[14:10](Re[4:0]) in Result[15:0] with the ModifiedRe generated in Steps S4, S6 or S7.

In Step S9, the PE 4 outputs Output[15:0] generated by the data reconstructor 7 and the OutputSF generated by the SF determination updater 6 to a downstream, and the process ends.

### (D-2) Example of Operation of SF Adjuster:

FIG. 12 illustrates an example of an operation performed in the SF adjuster 3 when the SF adjuster 3 receives the result of the arithmetic operation process in a single cycle inputted from each of the multiple upstream PEs 4. As illustrated in FIG. 12, in Step S11, the SF adjuster 3 obtains Input[15:0] and the InputSF from each upstream PE 4.

In Step S12, the multiplier 31 converts the is numerical value of each InputSF to a power of two (2^{InputSF}) by referring to the table 32a or by using the circuit logic.

In Step S13, the multiplier 31 generates Output[15:0] for each PE 4 by multiplying Input[15:0] obtained from each PE 4 with 2^{InputSF} obtained from each PE 4.

In Step S14, the multiplier 31 outputs each generated Output[15:0], and the process ends.

### (E) Effect of the One Embodiment:

As described above, the arithmetic array device 1 according to the one embodiment includes the systolic arithmetic array 2 including multiple PEs 4 connected in the array and the SF adjuster 3 connected to one or more PEs 4 being most downstream included in the arithmetic array 2. Each PE 4 shifts multiple bits of the exponent part in the result of the arithmetic operation performed on the input data inputted into the PE 4 according to the value of one or more bits of the exponent part in the exponent part of the result of the arithmetic operation. Further, each PE 4 updates the SF indicating the cumulative amount of shifting made by at least one PE 4 in accordance with the shifting. Further, each PE 4 outputs data obtained by shifting the multiple bits in the exponent part, as the input data, to a subsequent PE4 or the adjuster 3 being the downstream entity connected to a downstream side of the PE4, and also outputs the SF to the downstream entity. The SF adjuster 3 adjusts, based on the SF inputted from each of the one or more PEs 4, the input data inputted from each of the one or more PEs 4.

As described above, according to the arithmetic array device 1 of the one embodiment, a SF adjusting process (updating) is executed along with the arithmetic process on the input data in each PE 4. In other words, the SF adjusting process can be executed in the arithmetic array device 1. Therefore, as compared with a case where computation for adjusting the SF is carried out by the CPU, the one embodiment can suppress occurrence of the overhead due to communication between the CPUs so that the degrading of the computation performance of the arithmetic array 2 can be suppressed.

Further, according to the arithmetic array device 1 of the one embodiment, each PE 4 can execute the SF adjusting process for each arithmetic operation. As a result, since the SF can be finely adjusted, so that the result of the arithmetic operation of each arithmetic processing can be flexibly adjusted so as to be located within the expressible range of the low-accuracy floating point format, regardless of a content of the input data string, a content of the arithmetic operation process, and others. In other words, it is possible to flexibly shift the expressible range of the low-accuracy floating point format such that the results of the respective arithmetic operation processes are included in the appropriate positions.

In addition, each of the multiple PEs 4 according to the one embodiment right shifts the multiple bits in the exponent part when the value of the most significant bit of the exponent part is one. This can prevent the occurrence of the overflow.

Furthermore, when the value of the most significant bit and the value of the bit lower by one bit than the most significant bit are both zero, each of the multiple PEs 4 according to the one embodiment left shifts the multiple bits in the exponent part. This can prevent the occurrence of the underflow.

In addition, the SF adjuster 3 of the one embodiment adjusts the input data by converting the SF inputted from each of one or more PEs 4 into the value of a power of two and multiplying the input data inputted from each of one or more the PEs 4 by the value of a power of two. This can convert the data outputted from the arithmetic array 2 into the true value, so that an appropriate result of the arithmetic operation can be outputted from the arithmetic array device 1.

### (F) Modification:

Next, description will now be made in relation to a modification of the arithmetic array device 1 of the one embodiment. In the modification to the one embodiment, description will now be made in relation to an approach to store a history of updating (changing) the SF of each PE 4.

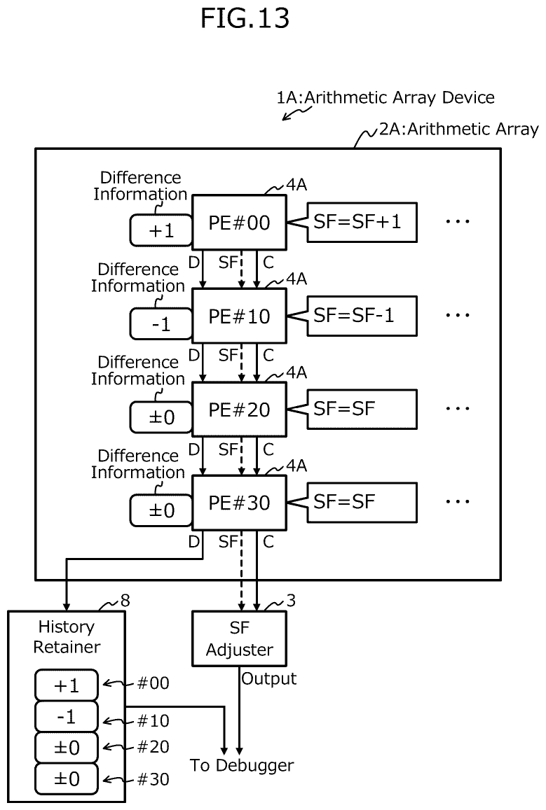

FIG. 13 is a block diagram schematically illustrating a configuration of an arithmetic array device 1A according to the modification. The arithmetic array device 1A includes an arithmetic array 2A, the SF adjuster 3 and a history retainer 8. The SF adjuster 3 is similar to that of the one embodiment except that the SF adjuster 3 can output the output data Output also to a debugger (not illustrated).

The arithmetic array 2A includes multiple PEs 4A and paths connecting respective PEs 4A to the history retainer 8. A remaining configuration in the arithmetic array 2A, such as a connecting configuration of the PEs 4A to propagate the data C and the SF, is similar to that in the arithmetic array 2 illustrated in FIG. 4. For convenience, FIG. 13 illustrates part of PEs 4A (e.g., PEs 4A corresponding to the PEs #00, #10, #20, and #30 included in the arithmetic array 2 of FIG. 4), and omits illustration of the remaining PEs 4A, the input data string, the output data string, and others.

In addition to the configuration of the PE 4A according to the one embodiment, the PE 4A includes a register that holds difference information of the SFs. The difference information is an example of information indicating a difference between the SF before updating and the SF after the updating (hereinafter also referred to as “updated SF”). After a predetermined-unit-based arithmetic operation process in the arithmetic array 2A is completed, the PEs 4A output the difference information (denoted by “D”) stored in the respective registers to the history retainer 8 sequentially from the most-downstream PE 4A through the paths.

FIG. 13 illustrates propagation paths similar to the propagation paths for the data C and the SF, which propagation paths serve as the paths between the PEs 4A and the history retainer 8. Like the propagation paths for the data C and the SF, the difference information D may be propagated through the PEs 4A from the most upstream PE 4A to the most downstream PE 4A in the arithmetic array 2A. Here, each of the most-downstream PEs 4A and the history retainer 8 may be connected. The same applies to other columns of the PEs 4A (for example, the column of the PEs #01, #11, #21, and #31) not appearing in the drawings. The paths are not limited to those illustrated in FIG. 13, and alternatively multiple paths those connect individual PEs 4A to the history retainer 8 may be provided.

The history retainer 8 is a storing element such as a register, a SRAM, and a ROM, and is an example of a storing device. The history retainer 8 holds a history (internal information) of updating the SF in each PE 4A of the arithmetic array 2A. For example, the history retainer 8 holds the difference information D as the history of updating the SF in each PE 4A in units of a column of the PEs 4A. As illustrated in FIG. 13, the history retainer 8 is a four-stage storing device that holds the difference information D received from the PEs 4A in the same column such that the difference information D from the most downstream PE 4A is stored at the bottom. In the example of FIG. 13, the number of the sender PE 4A of each difference information is attached to the corresponding piece of the difference information stored in the history retainer 8.

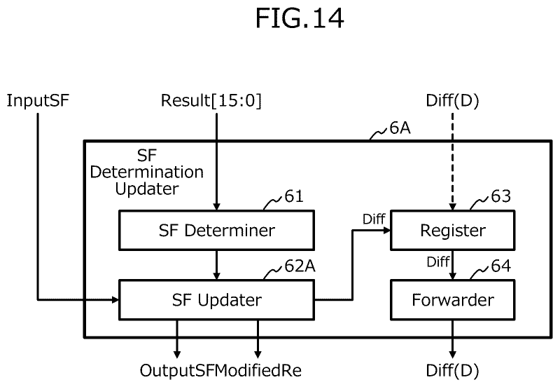

FIG. 14 is a block diagram schematically illustrating a configuration of a SF determination updater 6A of the modification. The SF determination updater 6A includes the SF determiner 61 similar to that included in the SF determination updater 6 illustrated in FIG. 7, and includes a SF updater 62A in place of the SF updater 62. The SF determination updater 6A includes a register 63 and a forwarder 64.

In addition to the process that the SF updater 62 performs, the SF updater 62A stores difference information (denoted by “Diff”), which is an addition value made to the InputSF to generate the OutputSF, into the register 63. For example, the addition value is “+1”, which is to be added to the InputSF, when the bits of the exponent part is right shifted, and is “−1”, which is to be added to the InputSF, when the bits of the exponent part is left shifted, and “+−0”, which is to be added to the InputSF, when the exponent part is maintained.

The register 63 holds the difference information Diff inputted from the SF updater 62A. In addition, the register 63 of the PE 4A except for the PEs 4A on the most upstream may retain the difference information Diff (difference information D) inputted from one or more of the upstream PEs 4A after outputting the difference information Diff inputted from the SF updater 62A.

The forwarder 64 outputs, as the difference information D, the difference information Diff held by the register 63 to the downstream PE 4A or the history retainer 8. For example, the forwarder 64 repeatedly carries out a forwarding process that reads the difference information Diff from the register 63 and outputs (stores) the read difference information Diff into the register 63 of the downstream PE 4A or, if the downstream entity of the PE 4A is the history retainer 8, to the history retainer 8.

The forwarding process may be started, for example, when a predetermined-unit-based arithmetic processing in the arithmetic array 2A which processing is exemplified by a tile-unit-based arithmetic operation process is completed, and may be finished when the difference information D held by the register 63 of the most upstream PE 4A is stored in the history retainer 8. In an example of FIG. 13, the forwarding process is repeatedly executed four times.

Next, description will now be made in relation to an example of an operation of the arithmetic array device 1A according to the modification. The example of an operation of the SF adjuster 3 of the modification is the same as that illustrated in FIG. 12.

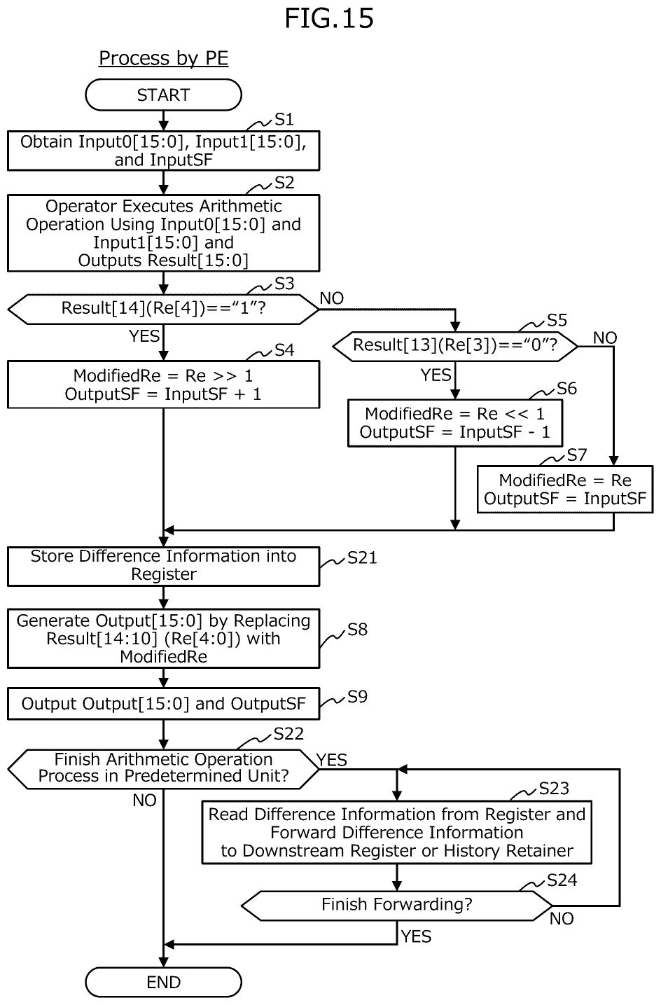

FIG. 15 is a flow diagram illustrating an example of an operation of each PE 4A in the arithmetic array 2A of the modification. The flow diagram illustrated in FIG. 15 includes Steps S21 to S24 in addition to Steps S1 to S9 illustrated in FIG. 11. The processes of Steps S1 to S9 in FIG. 15 are the same as the processes of Step S1 to S9 of FIG. 11.

As illustrated in FIG. 15, Step S21 is performed between Step S4, S6, or S7 and Step S8. In Step S21, the SF updater 62A stores the difference information Diff, which is the addition value for generating the OutputSF, into the register 63. Alternatively, Step S21 may be executed after Step S8 or S9, or may be executed in parallel with Step S8 or S9.

In Step S22 after Step S9, the forwarder 64 determines whether or not the predetermined-unit-based arithmetic operation process such as the tile-unit-based arithmetic operation process, has been completed. If the unit-based arithmetic operation process has not been completed (NO in Step S22), the process ends. If the predetermined-unit-based arithmetic operation process has been completed (YES in Step S22), the process proceeds to Step S23.

In Step S23, the forwarder 64 reads the difference information Diff from the register 63 and forwards the read difference information Diff to the register 63 of the downstream PE 4A or, if the PE 4A is the most downstream entity, to the downstream history retainer 8.

In Step S24, the forwarder 64 determines whether or not the forwarding has been completed, for example, whether or not the difference information Diff stored in the register 63 of the most upstream PE 4A has been stored in the history retainer 8. If the forwarding has not been completed (NO in Step S24), the process proceeds to Step S23. If the forwarding has been completed (YES in Step S24), the process ends.

As described above, the arithmetic array device 1A according to the modification is provided with the history retainer 8. Further, each PE 4A includes the register 63 that stores the difference information Diff indicating the difference between the SF before updating and the updated SF, and the forwarder 64 that, after completion of the predetermined-unit-based arithmetic operation process in the arithmetic array 2A, outputs the difference information Diff(D) to the history retainer 8.

Thus, for example, by associating the difference information D retained in the history retainer 8 with the output data Output outputted from the SF adjuster 3 in the debugging process, the debugger (not illustrated) can calculate backwards the arithmetic operation performed by each PE 4A in the arithmetic array 2A. Consequently, the debugging processing can be easily executed, so that the arithmetic array device 1A can be efficiently used.

### (G) Miscellaneous:

The techniques according to the one embodiment and the modification described above can be modified and implemented as follows.

For example, the number of PEs 4, and the number of columns and the number of rows of PEs 4 in the arithmetic array 2 are not limited to those illustrated in FIG. 4, and may be various numbers. Further, the blocks (e.g., functional blocks, circuit block) illustrated in FIG. 6 to FIGS. 9 and 14 may be merged by any combination or may be divided.

In addition, the one embodiment and the modification use FP16 as the low-accurate floating-point format, which is not however limited to FP 16. Alternatively, various floating-point format such as BF16 and FP8 which are different in the bit numbers (digit numbers) of the exponent part and the significand part from the FP16 may be used. If a floating-point format except for FP16 is used, bit number (digit number) of the exponent part to be shifted may be changed in the approach described in the one embodiment and the modification.

In one aspect, it is possible to suppress deterioration in the computational performance of the arithmetic array.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A systolic arithmetic array device comprising:
a systolic arithmetic array comprising a plurality of arithmetic operators connected in an array; and
an adjuster connected to one or more arithmetic operators being most downstream in the systolic arithmetic array, wherein
each of the plurality of arithmetic operators is configured to
shift a plurality of bits in an exponent part of a result of an arithmetic operation performed on input data inputted into the arithmetic operator in accordance with a value of one or more bits in the exponent part of the result of the arithmetic operation,
update shift information representing a cumulative amount of shifting made by at least one of the arithmetic operators in accordance with the shifting, and
output data obtained by shifting the plurality of bits in the exponent part, as the input data, to a subsequent arithmetic operator or the adjuster being a downstream entity connected to a downstream side of the arithmetic operator, and output the shift information to the downstream entity, and
the adjuster is configured to adjust, based on the shift information inputted from each of the one or more arithmetic operators, the input data inputted from each of the one or more arithmetic operators.

2. The systolic arithmetic array device according to claim 1, wherein
each of the plurality of arithmetic operators is further configured to
when a value of a most significant bit of the exponent part is one, right shift the plurality of bits in the exponent part.

3. The systolic arithmetic array device according to claim 1, wherein
each of the plurality of arithmetic operators is further configured to
when a value of a most significant bit of the exponent part and a value of a bit lower by one bit than the most significant bit are both zero, left shift the plurality of bits in the exponent part.

4. The systolic arithmetic array device according to claim 1, further comprising
a storing device, wherein
each of the plurality of arithmetic operators
comprises a register that stores difference information representing a difference between the shift information before updating and the shift information after the updating, and
after an arithmetic operation process of a given unit in the systolic arithmetic array is completed, outputs the difference information to the storing device.

5. The systolic arithmetic array device according to claim 1, wherein
the adjuster adjusts the input data by converting the shift information inputted from each of the one or more arithmetic operators into a value of a power of two and multiplying the input data inputted from each of the one or more arithmetic operators by the value of a power of two.

6. A computer-implemented method for controlling a systolic arithmetic array device, the method comprising
at each of a plurality of arithmetic operators connected in an array, the plurality of arithmetic operators being included in a systolic arithmetic array,
shifting a plurality of bits in an exponent part of a result of an arithmetic operation performed on input data inputted into the arithmetic operator in accordance with a value of one or more bits in the exponent part of the arithmetic result of the arithmetic operation,
updating shift information representing a cumulative amount of shifting made by at least one of the arithmetic operators in accordance with the shifting, and
outputting data obtained by shifting the plurality of bits in the exponent part, as the input data, to a subsequent arithmetic operator or an adjuster being a downstream entity connected to a downstream side of the arithmetic operator, and outputting the shift information to the downstream entity, the adjuster being connected to one or more arithmetic operators being most downstream in the systolic arithmetic array, and
at the adjuster
adjusting, based on the shift information inputted from each of the one or more arithmetic operators, the input data inputted from each of the one or more arithmetic operators.

7. The computer-implemented method according to claim 6, further comprising
at each of the plurality of arithmetic operators
when a value of a most significant bit of the exponent part is one, right shifting the plurality of bits in the exponent part.

8. The computer-implemented method according to claim 6, further comprising
at each of the plurality of arithmetic operators
when a value of a most significant bit of the exponent part and a value of a bit lower by one bit than the most significant bit are both zero, left shifting the plurality of bits in the exponent part.

9. The computer-implemented method according to claim 6, further comprising
at each of the plurality of arithmetic operators
storing difference information representing a difference between the shift information before the updating and the shift information after the updating into a register, and
after an arithmetic operation process of a given unit in the systolic arithmetic array is completed, outputting the difference information to a storing device.

10. The computer-implemented method according to claim 6, further comprising
at the adjuster
adjusting the input data by converting the shift information inputted from each of the one or more arithmetic operators into a value of a power of two and multiplying the input data inputted from each of the one or more arithmetic operators by the value of a power of two.
